(19) United States
(12) Patent Application Publication
(10) Pub. No.: US 2011/0195757 A1
(43) Pub. Date: Aug. 11, 2011

(54) ELECTRONIC DEVICE AND ALERTING METHOD OF INCOMING CALL

(75) Inventor: ZHI-PENG MA, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/757,311

(22) Filed: Apr. 9, 2010

(30) Foreign Application Priority Data
Feb. 8, 2010 (CN) 201010301368.3

(51) Int. Cl. H04B 1/38

(52) U.S. Cl. 455/567

(57) ABSTRACT

An electronic device includes a ring module, a vibration module, a noise sensing module, a storing module and a controlling module. The ring module plays a ring when receiving an incoming call. The vibration module generates vibration. The noise sensing module obtains a decibel (db) level of environment noise. The storing module stores a predetermined db level. The controlling module instructs the noise sensing module to obtain the db level of environment noise. The controlling module instructs the vibration module to vibrate after the controlling module determines the db level of environment noise is greater than the predetermined db level.

### BACKGROUND

1. Technical Field

The present disclosure relates to an electronic device and an alerting method of an incoming call of the electronic device.

2. Description of Related Art

Some electronic devices (such as a mobile phone) can transmit and receive sound, most commonly the human voice. When the mobile phone receives a call, the mobile phone rings. However, a user may not hear the ring in a noisy environment and may miss an important call.

### BRIEF DESCRIPTION OF THE DRAWINGS

FIG. 1 is a schematic view of an electronic device in accordance with one embodiment.

FIG. 2 is a flowchart of an alerting method of an incoming call of an electronic device according to an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming languages such as Java, C, or Assembly. One or more software instructions in the modules may be embedded in firmware, such as an EPROM. It is noteworthy, that modules may comprise connected logic units, such as gates and flip-flops, and programmable units such as programmable gate arrays or processors. The modules described herein may be implemented as software and/or hardware modules and may be stored in any type of computer-readable medium or other computer storage device.

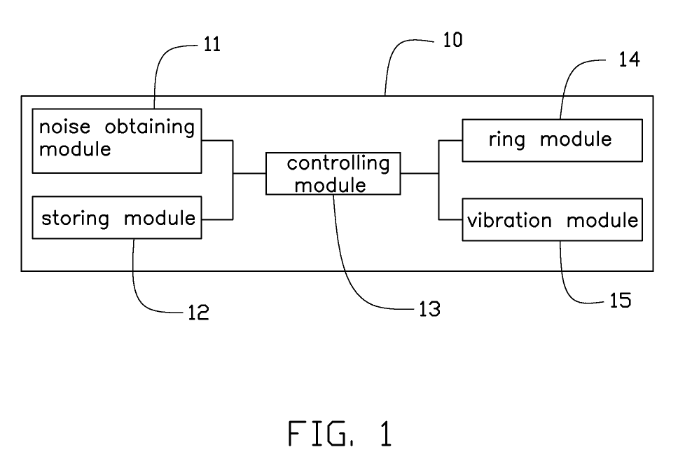

Referring to FIG. 1, an electronic device 10 includes a noise/sound sensing module 11, a storing module 12, a controlling module 13, a ring module 14, and a vibration module 15. In one embodiment, the electronic device 10 is a mobile phone, the vibration module 15 may be a vibrating motor, and the noise sensing module 11 may be a microphone.

The noise sensing module 11 can detect a decibel (db) level of environment noise. The storing module 12 stores a predetermined db level. For example, the predetermined db level is 30 db. The controlling module 13 instructs the noise sensing module 11 to obtain the db level of environment noise, and instructs the vibration module 15 to vibrate after the controlling module 13 determines the db level of environment noise is greater than the predetermined db level.

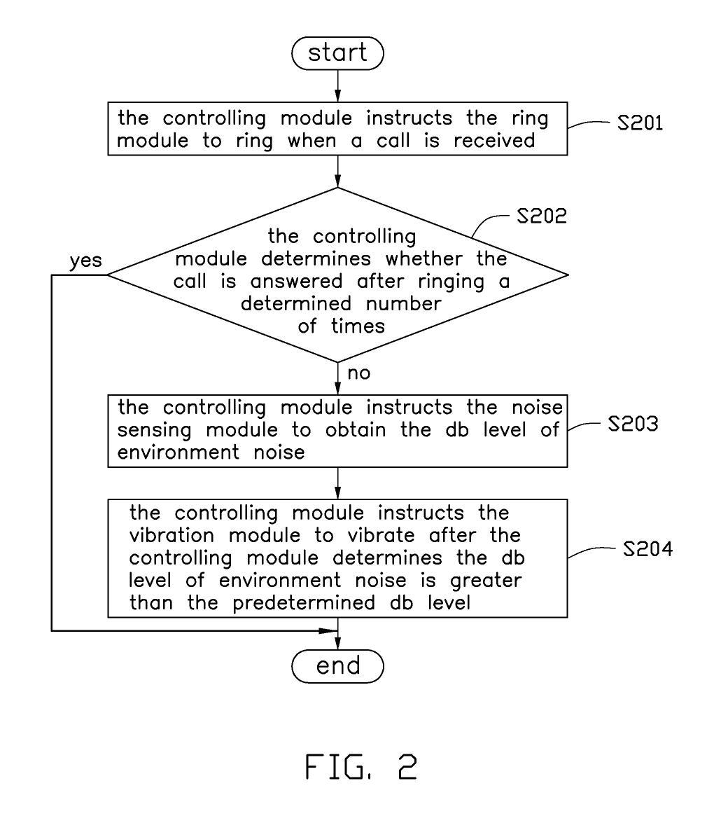

Referring to FIG. 2, one embodiment of an alerting method of an incoming call of an electronic device 10 includes the following blocks.

In block S201, the controlling module 13 instructs the ring module 14 to ring when a call is received.

In block S202, the controlling module 13 determines whether the call is answered after ringing a determined number of times. If yes, the process ends. If no, it goes to S203.

In block S203, the controlling module 13 instructs the noise sensing module 11 to obtain the db level of environment noise.

In block S204, the controlling module 13 instructs the vibration module 15 to vibrate after the controlling module 13 determines the db level of environment noise is greater than the predetermined db level.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An alerting method of an incoming call of an electronic device, the method comprising:
setting a predetermined decibel (db) level;
receiving the incoming call;
playing a calling ring;
detecting a db level of environment noise through a noise sensing module;
switching to a vibration mode after a controlling module determines the db level of environment noise is greater than the predetermined db level.

2. The method of claim 1, wherein the controlling module instructs a ring module to play the calling ring before switching to the vibration mode.

3. The method of claim 2, wherein the controlling module instructs the noise sensing module to detect the db level of environment noise after the playing the calling ring.

4. The method of claim 2, wherein the controlling module instructs the ring module to play the calling ring when detecting the db level of environment noise is less than the predetermined db level.

5. The method of claim 1, wherein the noise sensing module is a microphone.

6. An electronic device comprising:
a ring module capable of playing a ring when receiving an incoming call;
a vibration module capable of generating vibration;
a noise sensing module capable of sensing a decibel (db) level of environment noise;
a storing module capable of storing a predetermined db level;
a controlling module capable of instructing the noise sensing module, to obtain the db level of environment noise, and the vibration module to vibrate when the controlling module determines the db level of environment noise is greater than the predetermined db level.

7. The electronic device of claim 6, wherein the controlling module is capable of instructing the ring module to play the ring before instructing the vibration module to generate vibration.

8. The electronic device of claim 7, wherein the controlling module is capable of instructing the noise sensing module to obtain the db level of environment noise after playing the ring.

9. The electronic device of claim 6, wherein the controlling module is capable of instructing the ring module to play the ring when determining the db level of environment noise is less than the predetermined db level.

10. The electronic device of claim 6, wherein the noise sensing module is a microphone.
